(19) United States
(12) Patent Application Publication
(10) Pub. No.: US 2024/0348111 A1
(43) Pub. Date: Oct. 17, 2024

(54) SIX-PHASE MOTOR

(71) Applicants: HYUNDAI MOTOR COMPANY, Seoul (KR); KIA CORPORATION, Seoul (KR)

(72) Inventors: Min Ho Chae, Incheon (KR); Tae Yeong Lee, Hwaseong-si (KR)

(73) Assignees: HYUNDAI MOTOR COMPANY, Seoul (KR); KIA CORPORATION, Seoul (KR)

(21) Appl. No.: 18/376,218

(22) Filed: Oct. 3, 2023

(30) Foreign Application Priority Data
Apr. 11, 2023 (KR) 10-2023-0047617

(51) Int. Cl. H02K 1/16; H02K 1/27

(52) U.S. Cl. CPC H02K 1/16; H02K 1/27

(57) ABSTRACT

A six-phase motor includes a rotor including a plurality of magnets. The six-phase motor also includes a stator disposed to form an air gap with the rotor. The six-phase motor further includes coils, corresponding to six phases of the six-phase motor, disposed on the stator. Among the coils, coils corresponding to three phases are configured to have a different number of turns as compared to coils corresponding to the remaining of three phases.

### CROSS REFERENCE TO RELATED APPLICATION

The present application claims the benefit of and priority to Korean Patent Application No. 10-2023-0047617, filed Apr. 11, 2023, the entire contents of which are incorporated herein by reference.

### TECHNICAL FIELD

The present disclosure relates to a structure of a motor that can be used for driving a vehicle.

### BACKGROUND

A hybrid electric vehicle or an electric vehicle is typically driven by an electric motor in which the electrical energy is supplied from a battery mounted on the vehicle. The electrical energy supplied from the battery generates the necessary driving force to drive the motor.

The motor for the vehicle as described above should generally be a high-efficiency motor in order to satisfy the fuel efficiency and output performance of the vehicle.

Matters described in the background section are provided merely for promoting understanding of the background of the disclosure, and should not be taken as the prior art already known to a person having ordinary skill in the art.

### SUMMARY

Accordingly, the present disclosure has been made in view of the above problems. Embodiments of the present disclosure provide a six-phase motor in which copper loss and flux weakening control loss are reduced for a same operating point as compared to the conventional motor. Thus, the efficiency of the motor is improved, and ultimately, the fuel efficiency is improved by increasing the output performance of the vehicle.

According to an embodiment of the present disclosure, a six-phase motor is provided. The six-phase motor includes a rotor including a plurality of magnets. The six-phase motor also includes a stator disposed to form an air gap with the rotor. The six-phase motor further includes coils, corresponding to six phases of the six-phase motor, disposed in the stator. Among the coils, coils corresponding to three phases are configured to have a different number of turns as compared to coils corresponding to the remaining three phases.

Among the coils, the coils corresponding to the three-phase may be configured as a first coil type wound with a first number of turns, and the coils corresponding to the remaining three phases may be configured as a second coil type wound with a second number of turns less than the first number of turns of the first coil type.

The coils corresponding to the six phases may be inserted into a plurality of slots of the stator. Coils of the first coil type and the second coil type may be disposed together in each slot.

The first type coil may comprise an A-phase coil, a B-phase coil, and a C-phase coil.

The second type coil may comprise an X-phase coil, a Y-phase coil, and a Z-phase coil.

The A-phase coil, the B-phase coil, and the C-phase coil may be disposed sequentially along the circumferential direction of the stator.

The X-phase coil, the Y-phase coil, and the Z-phase coil may be disposed in the same order along the direction where the A-phase coil, B-phase coil, and C-phase coil are disposed.

The A-phase coil, the B-phase coil, the C-phase coil, the X-phase coil, the Y-phase coil, and the Z-phase coil may be disposed so that A-phase, X-phase, B-phase, Y-phase, C-phase, and Z-phase are repetitively formed sequentially along the circumferential direction of the stator.

The X-phase coil may be inserted into the slot in which the A-phase coil and the B-phase coil are inserted,

The Y-phase coil is inserted into the slot in which the B-phase coil and the C-phase slot are inserted, and

The Z-phase coil may be inserted into the slot in which the C-phase coil and the A-phase coil are inserted.

The A-phase coil may be inserted into an ith slot and i+1th slot adjacent to each other of the stator.

The B-phase coil may be inserted into an i+2th slot and i+3th slot of the stator.

The C-phase coil may be inserted into an i+4th slot and i+5th slot of the stator.

The X-phase coil may be inserted into an i+1th slot and i+2th slot of the stator.

The Y-phase coil may be inserted into an i+3th slot and i+4th slot of the stator;

The Z-phase coil may be inserted into an i+5th slot and i th slot of the stator.

Each of the A-phase coil, the B-phase coil, the C-phase coil, the X-phase coil, the Y-phase coil, and the Z-phase coil may be successively inserted into a multiple of two slots adjacent to each other.

The A-phase coil, the B-phase coil, and the C-phase coil may be inserted relatively radially outside the stator in the slot.

The X-phase coil, the Y-phase coil, and the Z-phase coil may be inserted relatively radially inside the stator in the slot.

Coils of the first coil type may be formed of a thickness different from a thickness of coils of the second coil type.

Coils of the first coil type and coils of the second coil type may be alternatingly inserted into a plurality of slots disposed along the circumferential direction of the stator.

Coils of the first coil type may comprise an A-phase coil, a B-phase coil, and a C-phase coil.

Coils of the second coil type may comprise the X-phase coil, the Y-phase coil, and the Z-phase coil.

Each of the A-phase coil, the X-phase coil, the B-phase coil, the Y-phase coil, the C-phase coil, and the Z-phase coil may be disposed sequentially in the plurality of slots along the circumferential direction of the stator.

Embodiments of the present disclosure allow for reducing the copper loss and flux weakening control loss for a same operating point as compared to the conventional motor so that the efficiency of the motor is improved, and ultimately, the fuel efficiency is improved by increasing the output performance of the vehicle.

### BRIEF DESCRIPTION OF THE DRAWINGS

FIG. 1 is a diagram describing a six-phase motor, according to an embodiment of the present disclosure.

FIG. 2 is a conceptual diagram showing coils, corresponding to six phases, disposed in a stator of the six-phase motor of FIG. 1, according to an embodiment of the present disclosure.

FIG. 3 is a diagram describing a six-phase motor, according to another embodiment of the present disclosure.

FIG. 4 is a conceptual diagram showing coils, corresponding to six phases, disposed in a stator of the six-phase motor of FIG. 3, according to an embodiment of the present disclosure.

FIG. 5 is a diagram showing a driving circuit for driving a six-phase motor, according to an embodiment of the present disclosure.

FIG. 6 is a performance curve of a motor that is driven by the driving circuit of FIG. 5, according to an embodiment of the present disclosure.

FIG. 7 is a diagram for describing effects of embodiments of the present disclosure.

### DETAILED DESCRIPTION

Hereinafter, embodiments of the present disclosure are be described in greater detail with reference to the accompanying drawings. In the accompanying drawings, for ease of understanding, the same reference numerals are used to denote the same components throughout the drawings, and in the following description, repetitive descriptions of the same components have been omitted.

With respect to constituent elements used in the following description, suffixes “module” and “unit” are given in consideration of only facilitation of description and do not have meaning or functions discriminated from each other.

In the following description, detailed descriptions of related art have been omitted in situations in which the subject matter of the present disclosure may be obscured thereby. In addition, the accompanying drawings are provided only for a better understanding of the embodiments described in the present specification and are not intended to limit technical ideas disclosed in the present specification. Therefore, it should be understood that the accompanying drawings include all modifications, equivalents and substitutions within the scope and spirit of the present disclosure.

Terms such as “first” and “second” may be used to describe various components, but the components should not be limited by the above terms. The above terms are used only for the purpose of distinguishing one component from another.

It should be understood that when a component is referred to as being “connected to” or “coupled to” another component, it may be directly connected to or coupled to another component or intervening components may be present. In contrast, when a component is referred to as being “directly connected to” or “directly coupled to” another component, there are no intervening components present.

As used herein, the singular form is intended to include the plural forms as well, unless context clearly indicates otherwise.

It should be further understood that the terms “comprises,” “includes,” etc. specify the presence of stated features, integers, steps, operations, elements, components, or combinations thereof, but do not preclude the presence or addition of one or more other features, integers, steps, operations, elements, components, or combinations thereof.

When a component, device, element, or the like of the present disclosure is described as having a purpose or performing an operation, function, or the like, the component, device, or element should be considered herein as being “configured to” meet that purpose or perform that operation or function.

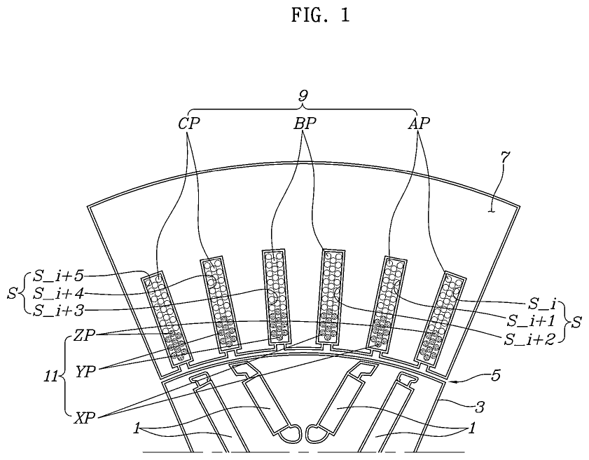

With reference to FIGS. 1 to 4, a six-phase motor of according to embodiments of the present disclosure includes a rotor 3 provided with a plurality of magnets 1 and a stator 7 disposed to form an air gap 5 with the rotor 3. Coils corresponding to six phases are disposed on the stator. Among the coils, coils corresponding to three phases are configured to have a different number of turns as compared to coils corresponding to the remaining three phases.

Among the coils, the coils corresponding to the three phases are configured as a first coil type wound with a first number of turns, and the remaining coil corresponding to the remaining three phases are configured as a second coil type wound with a second number of turns less than the first number of turns of the first coil type.

In an embodiment, the coils corresponding to the six phases of the six-phase motor are disposed in one stator 7, and the coils are separated into coils of a first coil type 9, having a relatively greater number of turns, and coils of a second coil type 11, having a relatively smaller number of turns. Accordingly, coils of different types are disposed in the same stator 7 to implement the six-phase motor.

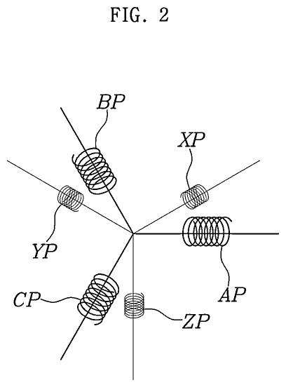

In an embodiment, as illustrated in FIGS. 1 and 2, the coils of the six-phase motor are inserted into a plurality of slots of the stator 7, where coils of the first coil type 9 and the second coil type 11 are disposed together in each slot.

In an embodiment, coils of the first coil type 9 comprise an A-phase coil AP, a B-phase coil BP, and a C-phase coil CP. Further, coils of The second coil type 11 comprise an X-phase coil XP, a Y-phase coil YP, and a Z-phase coil ZP. The A-phase coil AP, the B-phase coil BP, and the C-phase coil CP are disposed sequentially in the circumferential direction of the stator 7. The X-phase coil XP, the Y-phase coil YP, and the Z-phase coil ZP are also disposed sequentially along the direction in which the A-phase coil AP, the B-phase coil BP, and the C-phase coil CP are disposed.

The X-phase coil XP is inserted into the slot in which the A-phase coil AP and the B-phase coil BP are inserted. The Y-phase coil YP is inserted into the slot in which the B-phase coil BP and the C-phase coil CP are inserted. The Z-phase coil ZP is inserted into the slot in which the C-phase coil CP and the A-phase slot AP are inserted.

For example, in an embodiment, the A-phase coil AP is inserted into an i-th slot S_i and an i+1th slot S_i+1 adjacent to each other of the stator 7. The B-phase coil BP is inserted into an i+2th slot S_i+2 and an i+3th slot S_i+3 of the stator 7. The C-phase coil CP is inserted into an i+4th slot S_i+4 and an i+5th slot S_i+5 of the stator 7. The X-phase coil XP is inserted into the i+1th slot S_i+1 and the i+2th slot S_i+2 of the stator 7. The Y-phase coil YP is inserted into the i+3th slot S_i+3 and the i+4th slot S_i+4 of the stator 7. The Z-phase coil ZP is inserted into the i+5th slot S_i+5 and the i th slot S_i of the stator 7.

Accordingly, the A-phase coil AP, the B-phase coil BP, the C-phase coil CP, the X-phase coil XP, the Y-phase coil YP, and the Z-phase coil ZP are repetitively disposed in the order of A-phase, X-phase, B-phase, Y-phase, C-phase, and Z-phase along the circumferential direction of the stator 7.

In the embodiment of FIG. 1, each of the A-phase coil AP, the B-phase coil BP, the C-phase coil CP, the X-phase coil XP, the Y-phase coil YP, and the Z-phase coil ZP is in the form of being inserted into two slots successively in which the slots are placed adjacent to each other. However, according to the size and structure of the motor to be configured, each of the A-phase coil AP, the B-phase coil BP, the C-phase coil CP, the X-phase coil XP, the Y-phase coil YP, and the Z-phase coil ZP may have a configuration of being inserted successively into slots that are placed in a multiple of two slots adjacent to each other, such as four or six slots, in some embodiments.

For example, when the coil is inserted into the first slot to the fourth slot successively, the B-phase coil BP is inserted successively into the 5th slot to the 8th slot, and the X-phase coil XP may be successively inserted into the third to sixth slots.

The A-phase coil AP, the B-phase coil BP, and C-phase coil CP are inserted relatively radially outside the stator 7 in the slot. The X-phase coil XP, the Y-phase coil YP, and Z-phase coil ZP are inserted relatively radially inside the stator 7.

Accordingly, the magnetic field formed by the X-phase coil XP, the Y-phase coil YP, and the Z-phase coil ZP, having relatively a smaller number of turns, is formed closer to the rotor 3 than the magnetic field formed by the A-phase coil AP, the B-phase coil BP, and the C-phase coil CP to operate more effectively.

Coils of the first coil type 9 and may comprise windings of a different thickness as compared to coils of the second coil type 11.

Accordingly, the first type coil 9 and the second type coil 11 may comprise the thickness of windings and the number of turns different from each other.

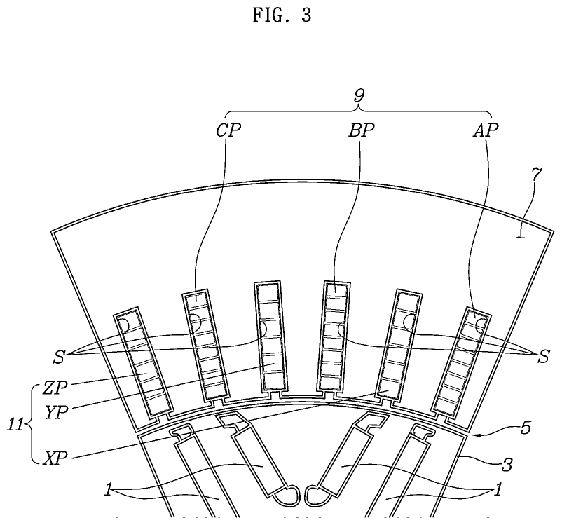

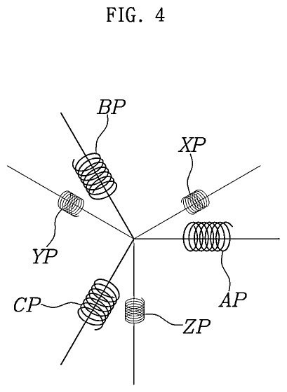

In another embodiment of the present disclosure, as illustrated in FIGS. 3 and 4, coils of the first coil type 9 and the second coil type 11 are alternatingly inserted into a plurality of slots S disposed along the circumferential direction of the stator 7.

In an embodiment, coils of the first coil type 9 comprise the A-phase coil AP, the B-phase coil BP, and the C-phase coil CP. Further, coils of the second coil type 11 comprise the X-phase coil XP, the Y-phase coil YP, and the Z-phase coil ZP. Each of the A-phase coil AP, the X-phase coil XP, the B-phase coil BP, the Y-phase coil YP, the C-phase coil CP, and the Z-phase coil ZP is successively disposed on the plurality of slots S disposed in the circumferential direction of the stator 7.

The configuration mentioned above is a configuration of a hairpin motor, for example. In an embodiment, each of the A-phase coil AP, the B-phase coil B, and the C-phase coil CP may be considered as being inserted into the slot S by eight turns, and each of the X-phase coil XP, and Y-phase coil YP, and the Z-phase ZP may be considered as being inserted into the slot S by six turns.

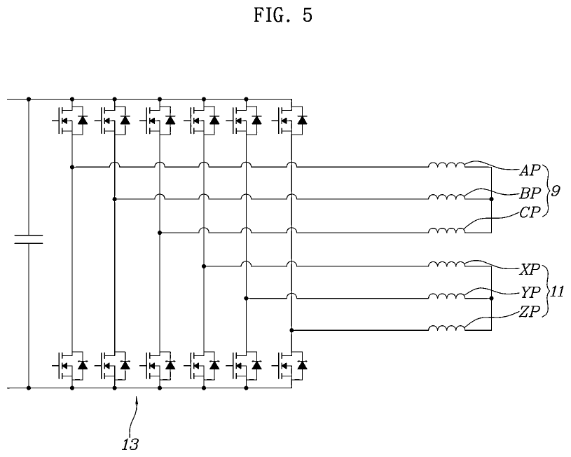

The six-phase motor of the present disclosure may comprise a driving circuit as shown in FIG. 5, according to an embodiment.

The coils of the six-phase motor are illustrated on the right side of FIG. 5. Among the coils, three coils on the upper side are of the first coil type 9, which comprises the A-phase coil AP, the B-phase coil BP, and the C-phase coil CP. Further, three coils on the lower side are of the second coil type 11, which comprises the X-phase coil XP, the Y-phase coil YP, and the Z-phase coil ZP. The driving circuit includes An inverter 13 comprising six legs to drive the six-phase motor.

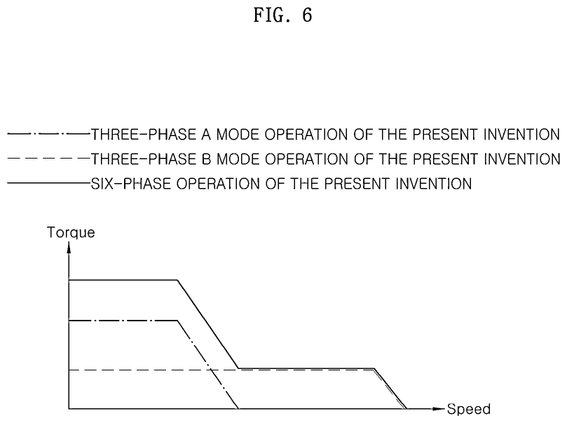

The motor may be driven by driving switching elements provided in each leg of the inverter 13. FIG. 6 illustrates a performance curve showing performance of the six-phase motor driven by the driving circuit of FIG. 5, according to an embodiment.

Referring to FIG. 6, in an embodiment, the six-phase motor may implement a three-phase A mode operation driven by using only the first type coils 9, a three-phase B mode operation driven by using only the second type coils 11, and a six-phase operation.

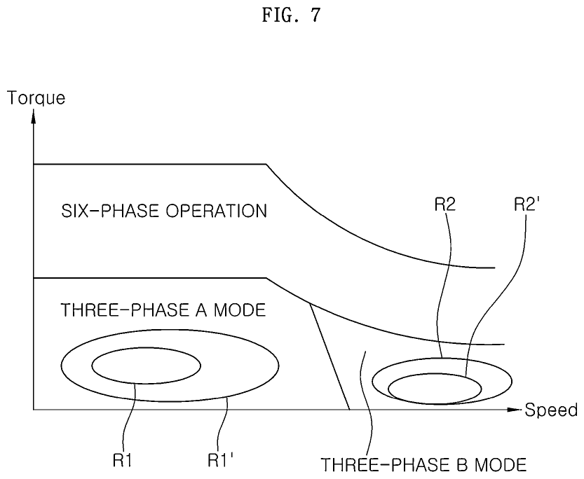

Referring to FIG. 7, more detailed effects of embodiments of the present disclosure are as follows.

In a relatively low-speed motor operating region, when the motor according to embodiments of the present disclosure is operating in the three-phase A mode operation, compared to the conventional motor driven at the same operating point, the required current is reduced, and the copper loss is reduced, thereby expanding R1, a region with relatively excellent efficiency, can be expanded to the region R1′.

For example, coils of the first coil type 9 used for the three-phase A mode operation have a relatively greater number of turns than the coil corresponding to each phase in a conventional six-phase motor of the same size. Accordingly, the copper is reduced as the required current is reduced compared to the operating point.

In a relatively high-speed motor operating region, when the motor according to embodiments of the present disclosure is operating the three-phase B mode operation, compared to the conventional motor driven at the same operating point, the flux weakening control loss is reduced, and the back electromagnetic field (EMF) is reduced, thereby obtaining an effect in which R2, which is a relatively low-efficiency operating region, is reduced to the region R2′.

For example, coils of the second coil type 11 used in the three-phase B mode operation have a relatively smaller number of turns compared to the coil corresponding to each phase in the conventional six-phase motor of the same size, when comparing the same operating point, it may obtain effects of reducing the flux weakening loss by reducing the back EMF.

Therefore, embodiments of the present disclosure allow reducing the copper loss and flux weakening control loss for the same operating point as compared to the conventional motor. Thus, the efficiency of the motor is improved, and ultimately the fuel efficiency is improved by increasing the output performance of the vehicle.

Although the present disclosure has been shown and described with respect to certain embodiments, it should be understood by those having ordinary skill in the art that the present disclosure may be variously modified and altered without departing from the spirit and scope of the present disclosure as defined by the following claims.

What is claimed is:

1. A six-phase motor, comprising:
a rotor including a plurality of magnets;
a stator disposed to form an air gap with the rotor; and
coils, corresponding to six phases of the six-phase motor, disposed on the stator,
wherein among the coils, coils corresponding to three phases are configured to have a different number of turns as compared to coils corresponding to the remaining three phases.

2. The six-phase motor of claim 1, wherein
among the coils, the coils corresponding to the three phases are configured as a first coil type wound with a first number of turns; and
the coils corresponding to the remaining three phases are configured as a second coil type wound with a second number of turns less than the first number of turns of the first coil type.

3. The six-phase motor of claim 2, wherein
the coils corresponding to the six phases are inserted into a plurality of slots of the stator, wherein coils of the first coil type and the second coil type are disposed together in each slot.

4. The six-phase motor of claim 3, wherein
coils of the first coil type comprise an A-phase coil, a B-phase coil, and a C-phase coil, and
coils of the second coil type comprise an X-phase coil, a Y-phase coil, and a Z-phase coil, and
wherein
the A-phase coil, the B-phase coil, and the C-phase coil are disposed sequentially along a circumferential direction of the stator, and
the X-phase coil, the Y-phase coil, and the Z-phase coil are disposed sequentially along the circumferential direction in which the A-phase coil, the B-phase coil, and the C-phase coil are disposed.

5. The six-phase motor of claim 4, wherein
the A-phase coil, the B-phase coil, the C-phase coil, the X-phase coil, the Y-phase coil, and the Z-phase coil are repetitively disposed in an order of A-phase, X-phase, B-phase, Y-phase, C-phase, and Z-phase along the circumferential direction of the stator.

6. The six-phase motor of claim 5, wherein
the X-phase coil is inserted into a slot in which the A-phase coil and the B-phase coil are inserted,
the Y-phase coil is inserted into a slot in which the B-phase coil and the C-phase coil are inserted, and
the Z-phase coil is inserted into a slot in which the C-phase coil and the A-phase coil are inserted.

7. The six-phase motor of claim 6, wherein
the A-phase coil is inserted into an ith slot and an i+1th slot, adjacent to each other, of the stator;
the B-phase coil is inserted into an i+2th slot and i+3th slot of the stator;
the C-phase coil in inserted into an i+4th slot and i+5th slot of the stator;
the X-phase coil is inserted into an i+1th slot and i+2th slot of the stator;
the Y-phase coil is inserted into an i+3th slot and i+4th slot of the stator; and
the Z-phase coil is inserted into an i+5th slot and i th slot of the stator.

8. The six-phase motor of claim 6, wherein
each of the A-phase coil, the B-phase coil, the C-phase coil, the X-phase coil, the Y-phase coil, and the Z-phase coil is successively inserted into a multiple of two slots adjacent to each other.

9. The six-phase motor of claim 6, wherein
the A-phase coil, the B-phase coil, and the C-phase coil are inserted relatively radially outside the stator in the slot in which the A-phase coil, the B-phase coil, and the C-phase coil are inserted; and
the X-phase coil, the Y-phase coil, and the Z-phase coil are inserted relatively radially inside the stator in the slot in which the X-phase coil, the Y-phase coil, and the Z-phase coil are inserted.

10. The six-phase motor of claim 2, wherein
coils of the first coil type are formed of a thickness different from a thickness of coils of the second coil type.

11. The six-phase motor of claim 2, wherein
coils of the first coil type and coils of the second coil type are alternatingly inserted into a plurality of slots disposed along a circumferential direction of the stator.

12. The six-phase motor of claim 11, wherein
coils of the first coil type comprise an A-phase coil, a B-phase coil, and a C-phase coil;
coils of the second coil type comprise an X-phase coil, a Y-phase coil, and a Z-phase coil; and
each of the A-phase coil, the B-phase coil, the C-phase coil, the X-phase coil, the Y-phase coil, and the Z-phase coil is disposed sequentially in the plurality of slots along the circumferential direction of the stator.
